(19) United States
(12) Patent Application Publication
(10) Pub. No.: US 2010/0243946 A1
(43) Pub. Date: Sep. 30, 2010

(54) METHODS OF MAKING HIGH RESISTIVITY MAGNETIC MATERIALS

(75) Inventors: Francis Johnson, Clifton Park, NY (US); Ayman Mohamed Fawzi El-Refaie, Niskayuna, NY (US); Lembit Salasoo, Schenectady, NY (US); Venkat Subramaniam Venkataramani, Clifton Park, NY (US); Thomas Robert Raber, Schenectady, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/414,804

(22) Filed: Mar. 31, 2009

(51) Int. Cl. H01F 1/04; H01F 1/00; B29C 71/04; B28B 1/00; B28B 3/26

(52) U.S. Cl. 252/62.55; 252/62.51 R; 264/428; 264/604; 264/319

(57) ABSTRACT

A method to make a high resistivity permanent magnetic material comprising a non-conductive phase and a permanent magnetic phase microstructure, is disclosed. The method comprises the steps of, (a) disposing at least one layer comprising a non-conductive powder and at least one layer comprising a permanent magnetic powder adjacent to each other to obtain a multilayer, (b) compressing the multilayer, and (c) sintering the multilayer. A method to make a high resistivity soft magnetic material comprising a microstructure comprising a bulk metallic glass phase and a soft magnetic crystalline metal phase, is also disclosed.

### CROSS REFERENCE TO RELATED APPLICATIONS

This application is related to co-pending U.S. patent application, Docket Number 225697-1, Ser. No. ______, entitled “Electric Machine” filed contemporaneously herewith, which application is hereby incorporated by reference.

### BACKGROUND

The invention relates generally to electrical machines, and more specifically to permanent magnet electrical machines.

Environmental considerations are a primary reason for developing fuel efficient machines. For example, in the automobile industry, there is a current move towards developing hybrid automobiles, as these have been shown to be more fuel efficient than conventional fossil fuel powered automobiles.

The thrust to develop fuel efficient machines, for instance, for use in hybrid automobiles, will have to be tempered with a cost of manufacturing such machines. Any machine technology that achieves energy efficiency at an undue manufacturing cost will likely not be commercially viable.

Current challenges facing development of cost effective electrical machines for hybrid automobiles are related to power density and efficiency considerations. Current machine technologies suffer from high stator core and rotor magnet losses due to their high speeds and winding structures. Attempts to design efficient stators and rotors to mitigate the above losses often result in an increase in complexity of their design, which in turn, makes electrical machines incorporating such designs commercially unattractive.

An electrical machine having a level of efficiency that is enhanced over currently available electrical machines and that can be manufactured in a cost-efficient manner would be highly desirable.

### BRIEF DESCRIPTION

Embodiments of the invention are directed towards an electric machine. More specifically, embodiments of the invention are directed towards an permanent magnet electric machines, for instance, interior permanent magnet electrical machines and surface permanent magnet electrical machines.

A method to make a high resistivity permanent magnetic material comprising a non-conductive phase and a permanent magnetic phase microstructure, said method comprising the steps of, (a) disposing at least one layer comprising a non-conductive powder and at least one layer comprising a permanent magnetic powder adjacent to each other to obtain a multilayer, (b) compressing the multilayer, and (c) sintering the multilayer.

A method to make a high resistivity soft magnetic material comprising a microstructure comprising a bulk metallic glass phase and a soft magnetic crystalline metal phase, said method comprising the steps of (a) mixing a bulk metallic glass material and a soft magnetic crystalline metal material to obtain a first composite, (b) thermomechanically processing the first composite to obtain a high resistivity soft magnetic composite, and (c) quenching the high resistivity soft magnetic composite to obtain the high resistivity soft magnetic material.

These and other advantages and features will be more readily understood from the following detailed description of preferred embodiments of the invention that is provided in connection with the accompanying drawings.

### DRAWINGS

FIG. 1 is a perspective view of a prior art electrical machine.

FIG. 2 is a schematic view of a prior art electrical machine.

FIG. 3 depicts, in tabular form, results of calculations of winding factor K_{w} for a wide range of possible stator slot and rotor pole combinations that can support fractional slot concentrated windings, in accordance with embodiments of the invention.

FIG. 4 is a schematic view of an interior permanent magnet electrical machine in accordance with an embodiment of the invention.

FIG. 5 is a schematic view of a surface permanent magnet electrical machine in accordance with an embodiment of the invention.

FIG. 6 is a schematic view of an “inside-out” configuration permanent magnet electrical machine in accordance with an embodiment of the invention.

FIG. 7 is a flow chart depicting a method to make a high resistivity permanent magnetic material in accordance with an embodiment of the invention.

FIG. 8 is a schematic view of a multilayer as recited in the method shown in FIG. 7, in accordance with an embodiment of the invention.

FIG. 9 is a scanning electron microscope image of a multilayer as recited in the method shown in FIG. 7, in accordance with an embodiment of the invention.

FIG. 10 is a flow chart depicting a method to make a high resistivity soft magnetic material in accordance with an embodiment of the invention.

FIG. 11 is a schematic representation of a process which may be employed to perform the method shown in FIG. 10, in accordance with an embodiment of the invention.

FIG. 12 shows results of an energy dispersive X-ray analysis study to confirm a nature of a high resistivity soft magnetic material in accordance with an embodiment of the invention.

FIG. 13 shows results of an energy dispersive X-ray analysis study to confirm a nature of a high resistivity soft magnetic material in accordance with an embodiment of the invention.

FIG. 14 is a graphical representation of results of measurement of magnetization as a function of applied magnetic field for a high resistivity soft magnetic material in accordance with an embodiment of the invention.

### DETAILED DESCRIPTION

In the following description, whenever a particular aspect or feature of an embodiment of the invention is said to comprise or consist of at least one element of a group and combinations thereof, it is understood that the aspect or feature may comprise or consist of any of the elements of the group, either individually or in combination with any of the other elements of that group.

In the following specification and the claims that follow, the singular forms “a,” “an,” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” or “substantially,” may not be limited to the precise value specified, and may include values that differ from the specified value. In at least some instances, the approximating language may correspond to the precision of an instrument for measuring the value.

As used herein, the terms “electric machine,” and “electrical machine” may sometimes be used interchangeably.

As used herein, the term “within,” when used in context of discussion of any physical entity may refer to a bulk of the physical entity, or it may refer to a surface of the physical entity, or it may refer to both the bulk and the surface of the physical entity.

As used herein, the term “adjacent,” when used in context of discussion of different entities, for instance, layers, comprising, for instance, a multilayered entity that in its final form contains a magnetic material, may refer to the situation where the entities under discussion are disposed immediately next to each other, that is, are contiguous, or it may also refer to a situation wherein intervening entities are disposed between the entities under discussion, that is, the entities under discussion are non-contiguous. Additionally, the entities themselves may be “green,” that is, they may be at a non-final stage of their manufacture.

In the present discussions it is to be understood that, unless explicitly stated otherwise, any range of numbers stated during a discussion of any region within, or physical characteristic of, for instance, a permanent magnet machine, is inclusive of the stated end points of the range.

Electric machines convert electrical energy into mechanical motion and vice versa. Electric machines typically consist of a stator that produces a rotating field when excited by alternating multi-phase current and a rotor (which produces a rotating field), and operate through an interaction of magnetic flux and electric current to produce rotational speed and torque. The considerations related to design and purpose of the stator, and of the rotor, are well known in the art. For instance, one of the key considerations concerns eddy current losses within the stator and rotor during operation of the electrical machine. To reduce eddy current losses, the rotors and stators have traditionally been fabricated out of thin laminations. Non-limiting examples of materials from which the laminations may be fabricated include silicon steel.

A traditional approach to further reduce eddy current losses has been fabricating the stator and/or the rotor from thin laminations, hence reducing the machine stacking factor. However, this approach has a disadvantage in that it results in an increase in the size of the electrical machine. Therefore, this approach has only limited feasibility in mitigating eddy current losses within electric machines.

The need for low cost, high performance, and high efficiency electrical machines is self-evident. A non-limiting example of the use of electrical machines is in traction applications. Operation at high speeds is a typical feature that results in electrical machines delivering enhanced “high” levels of performance. Embodiments of the invention disclosed herein include an internal permanent magnet machine that delivers enhanced performance than currently available electrical machines. Embodiments of the invention disclosed herein also include a surface permanent magnet machine that delivers enhanced performance than currently available electrical machines. Further embodiments of the invention disclosed herein include “regular” electrical machines, wherein the electrical machine comprises a stator and a rotor wherein an outer diameter of the stator is greater than an outer diameter of the rotor. Further embodiments of the invention disclosed herein include “inside-out” electrical machines, wherein the electrical machine comprises a stator and a rotor wherein an outer diameter of the rotor is greater than an outer diameter of the stator. Further embodiments of the invention disclosed herein include high resistivity magnetic materials and methods of making the same. The high resistivity magnetic materials may include soft magnetic materials or hard magnetic materials. Embodiments of the invention also include permanent magnet machines which include high resistivity magnetic materials.

As mentioned, high-speed electrical machines can achieve high levels of operational performance. One of the key challenges of high-speed operation of such electrical machines is the eddy current losses in the stator and in the rotor. Efficient high-speed machines can be achieved if a mechanism to reduce the inevitable eddy current losses can be devised. Further, it will be appreciated that the considerations related to the design of such a mechanism will involve at least structural and material aspects.

Embodiments of the invention disclosed herein propose high performance permanent magnet electric machines that utilize high resistivity magnetic materials. Non-limiting embodiments of the permanent magnet electrical machine include interior permanent magnet electrical machines and surface permanent magnet electrical machines. The magnetic materials can be in the form of a nanostructured powder. Furthermore, the magnetic materials can be soft, or hard. Aspects of the invention are related to the methods of making soft magnetic material, and hard magnetic materials are discussed in detail below within the discussions related to Example I, and Example II respectively. Quite generally, as is the practice in the art, “hard” magnetic materials may also be referred to as “permanent” magnetic materials.

Embodiments of the electric machine disclosed herein can function as a high-speed electric machine. For a given power rating, this may allow one to reduce the size of an electric machine. This in turn may result in an increased power density (that is, a power output per unit volume of the electrical machine) within the electric machine, which in turn may result in an enhanced performance of the electric machine.

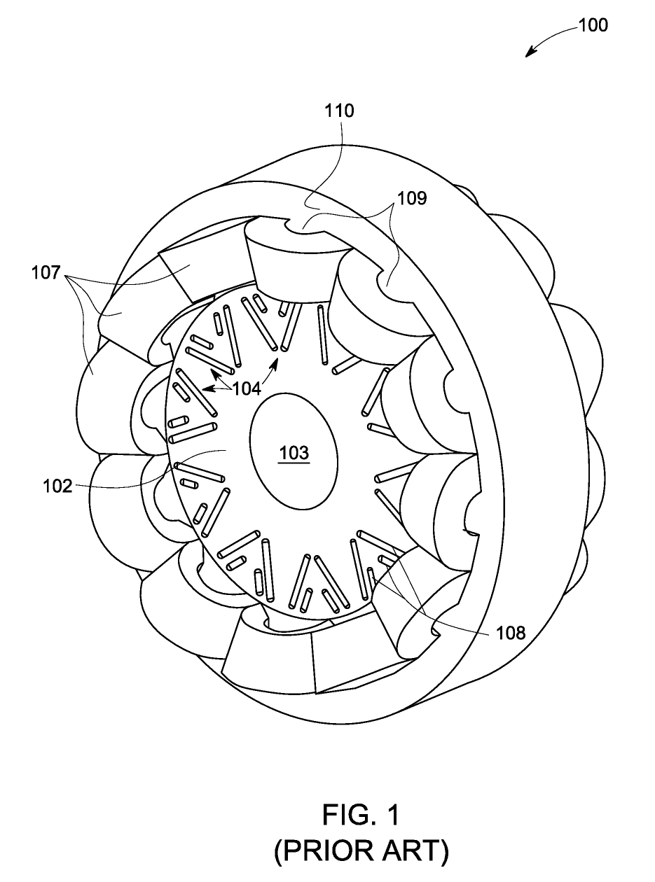

In a typical prior art electrical machine 100 shown in perspective view in FIG. 1, a generally cylindrical rotor 102 comprises a plurality of rotor poles 104, the individual poles of which are generally circumferentially disposed within the rotor 102. A generally cylindrical shaft 103 is defined as a generally centrally disposed opening within the rotor 102. The plurality of poles 104 may comprise a plurality of permanent magnets 108. Disposed cicumferentially enclosing the rotor 102 is a generally cylindrical stator 110. The stator has a plurality of stator teeth 109 facing the plurality of rotor poles 104 and a plurality of slots (not indicated). Each of the plurality of stator teeth 109 are wound with coils of wire 107 such that supplying electric current to the coils causes a production of a rotating magnetic field. This rotating magnetic field interacts with a magnetic field on the rotor 102 side and motivates the rotor 102 to rotate. That is, electromagnetic energy supplied to the coils is converted to mechanical motion which in turn produces torque.

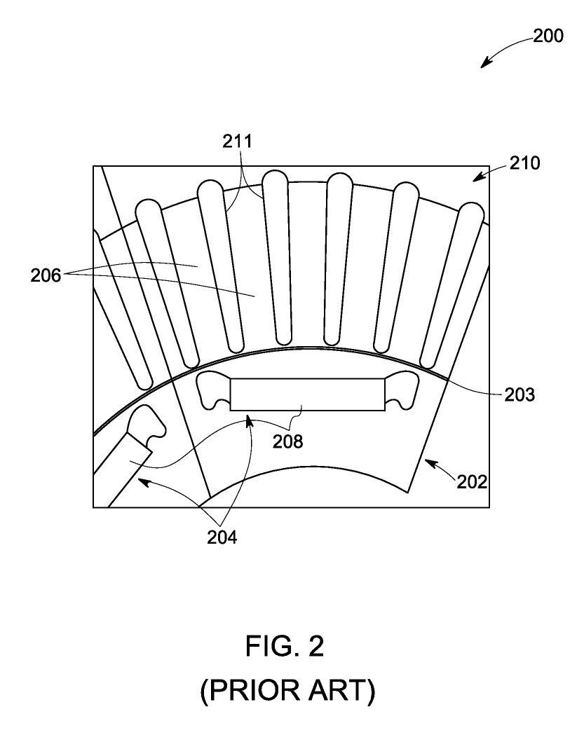

In a typical prior art electrical machine 200 shown schematically in FIG. 2, a generally cylindrical rotor 202 comprises a plurality of rotor poles 204, the individual poles of which are generally circumferentially disposed within the rotor 202. A plurality of permanent magnets 208 are disposed within the plurality of rotor poles 204. Quite generally, each of the plurality of magnets 208 may be said to define a corresponding pole of the plurality of rotor poles 204. Each of the plurality of permanent magnets 208 may be segmented (not depicted). In the discussions herein, therefore, the phrases, “plurality of rotor poles,” and “plurality of permanent magnets,” may sometimes be used interchangeably. Therefore, as with the plurality of poles 204, the plurality of permanent magnets 208, may also be considered to be included within the rotor 202. Disposed circumferentially enclosing the rotor 202 is a generally cylindrical stator 210. An air gap 203 separates the rotor 202 and the stator 210. The stator has a plurality of stator teeth 206 facing the plurality of rotor poles 204, and a plurality of stator slots 211. Each of the plurality of stator teeth 206 are wound with coils of wire (not shown) such that supplying electric current to the coils causes a production of a rotating magnetic field. This rotating magnetic field interacts with a magnetic field on the rotor 202 side and motivates the rotor 202 to rotate. That is, electromagnetic energy supplied to the coils is converted to mechanical motion which in turn produces torque.

Electrical machines including permanent magnets may be considered as magnetic circuits. The magnetic circuit defined by an electrical machine may then include, a rotor (for example, of type 202) including a plurality of rotor poles (for example, of type 204), a plurality of permanent magnets (for instance, of type 208), a stator (for example, of type 210) including a plurality of stator teeth (for example, of type 206), a plurality of stator slots (for example, of type 211), and an air gap between the rotor and the stator (for example, of type 203). At any instant during rotation of the rotor, the magnetic circuit will have a reluctance. The reluctances of the magnetic circuits is a function of, for example, a number of the rotor 202 transitions, from being opposite a stator to being opposite a gap between the teeth. A reluctance torque is typically sequent due to changes in the reluctance of magnetic circuits in the electrical machine due to the rotation of the rotor. The generated reluctance torque is a factor governing the electrical efficiency of the electrical machine. As is known in the art, higher reluctance torque leads to a reduction in permanent magnet torque. The reduction in permanent “hard” magnet torque in turn results in a reduction in the required amount of hard magnetic material within the electrical machine. The reduction in required amount of hard magnetic material in turn results in a reduction in the cost of the electrical machine.

The plurality of rotor poles 204 may be considered to “house” the plurality of permanent magnets 208. The plurality of permanent magnets 208 can be subjected to significant eddy current losses within the rotor 202 due to the asynchronous rotating fields from the stator side. The eddy current losses within the rotor 202 in turn contribute to a decrease in the overall efficiency of the electric machine 200. Therefore, an understanding of the spatial distribution, and corresponding magnitude of the eddy current losses within the plurality of permanent magnets 208 is required for mitigation of eddy current losses within the rotor 202.

A widely used metric to quantify the performance of an electrical machine is the winding factor of the electrical machine. Performance attributes, such as for instance, the efficiency, is related to the winding factor, and the winding factor has a maximum possible value of unity.

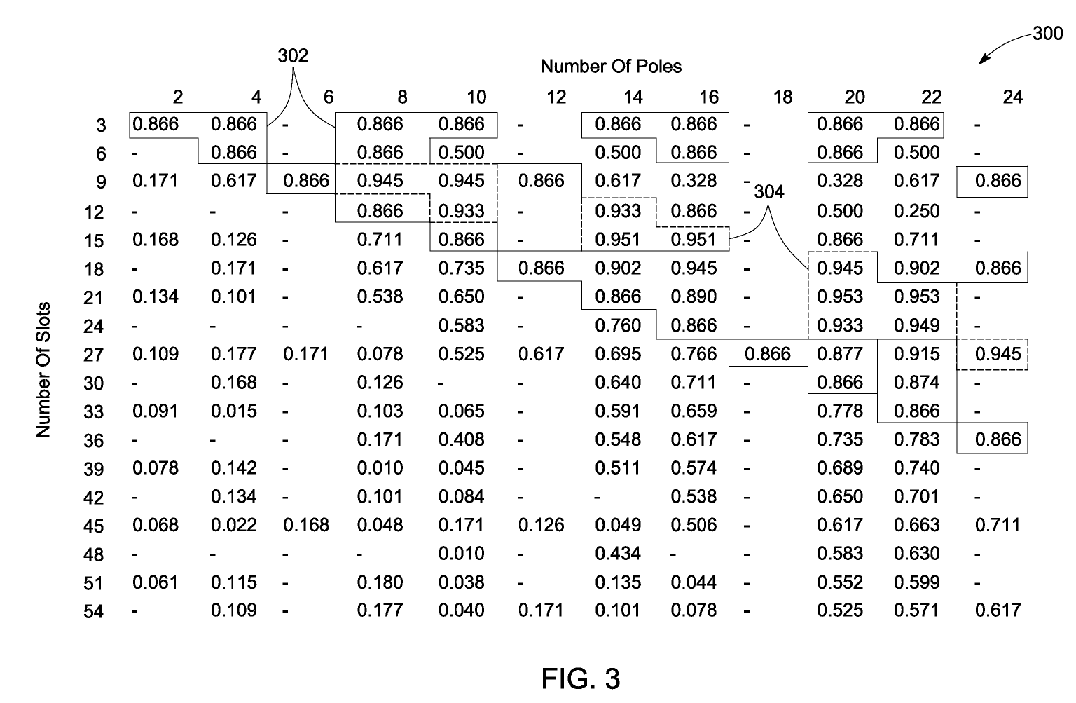

State of the art electrical machines are able to achieve a winding factor “K_{w}” of about 0.866 or higher. For instance, FIG. 3 depicts in tabular form 300, the results of calculations of K_{w} for a wide range of possible stator slot and rotor pole combinations that can support fractional slot concentrated windings. The set of values of K_{w} 302 (shown enclosed within “solid” boundary lines) represents the current state of the art for fractional slot concentrated windings. Higher values of K_{w}, for example, the set of values 304 (shown enclosed within “dashed” boundary lines) are desirable. However, as noted earlier, electrical machines with the required number of rotor poles and stator slots to support fractional slot concentrated windings also display an attendant and usually unacceptable increase in eddy current losses due to the space harmonic components of the electrical windings. The ability to meaningfully realize high-speed electrical machines with higher winding factors according to currently available technology is limited by an attendant increase in eddy current losses. Embodiments (discussed below) of the electrical machine according to the present invention are able deliver a winding factor greater than about 0.9 while delivering enhanced efficiency levels.

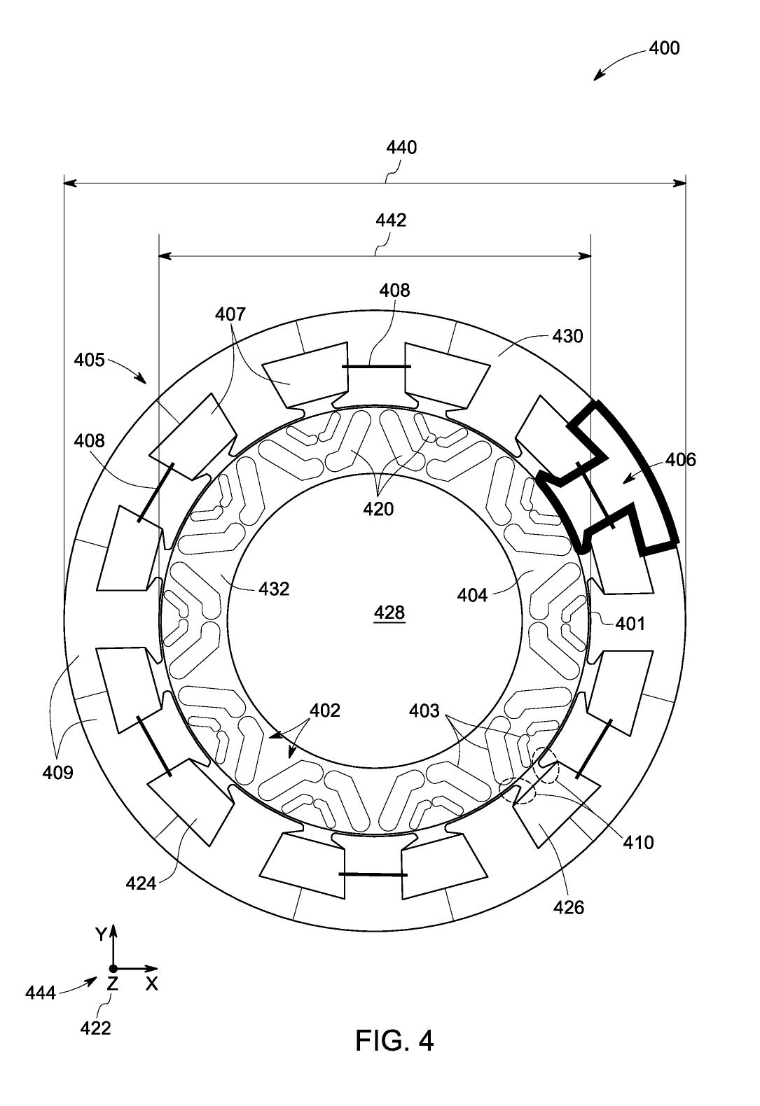

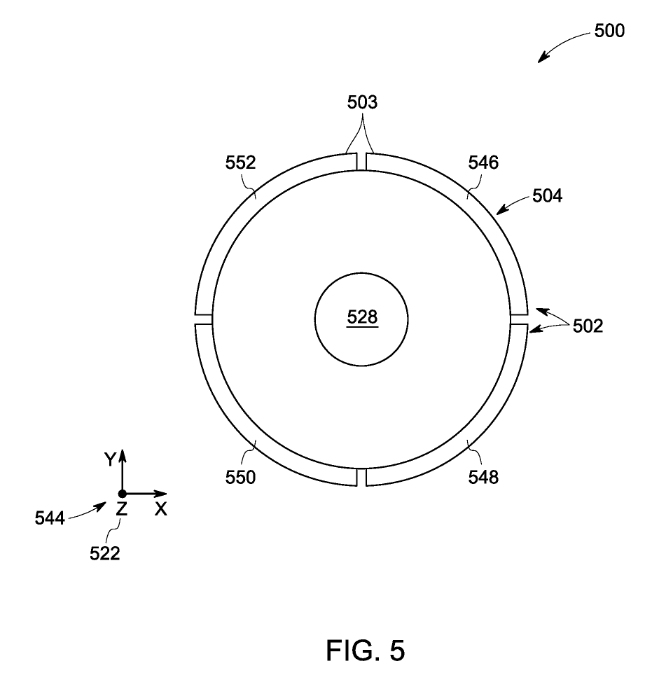

According to an embodiment of the invention, a permanent magnet electrical machine 400 is disclosed. As shown in FIG. 4, according to the embodiment 400, a plurality of poles 402 are disposed within the rotor 404. A generally cylindrical shaft 428 is defined as a generally centrally disposed opening within the rotor 404. Quite generally, the volume 420 defined and within by the plurality of poles 402 may include a plurality of permanent “hard” magnets 403. This may aid in enhancing a reluctance torque component within the rotor 404. As discussed herein, the enhancement in the reluctance torque component in turn result in a reduction in the amount of hard magnetic material required within the plurality of hard magnets 403 within the rotor 404. Those skilled in the art would appreciate that, since the hard magnetic material is “embedded” within the rotor 404, the embodiment 400 may quite generally be considered as an “interior permanent magnet electric machine.” (Such as embodiment is to be distinguished from a “surface permanent magnet electric machine” that is disclosed herein (see FIG. 5) as per alternate embodiments of the invention.) This in turn may result in a reduction of the cost of the electric machine embodiment 400. Those skilled in the art would appreciate that the rotor 404 may be fabricated from a plurality of rotor laminations (not shown) stacked together along a thickness direction 422 (which lies along a z-axis of a right-handed Cartesian coordinate system 444) of the rotor 404. Non-limiting examples of materials from which the rotor 404 may be fabricated include silicon steel, and hard magnetic materials and soft magnetic materials discussed respectively in context of Example I and Example II below.

In one embodiment, the electrical machine may have a stator 405 including a plurality of segmented structures (one of which is indicated via reference numeral 406), a plurality of stator slots 407, and a plurality of fractional slot concentrated electrical windings 408, wherein each electrical winding of the plurality of fractional slot concentrated electrical windings 408 are individually wound around a tooth belonging to the plurality of stator teeth 409. Those skilled in the art would appreciate that the stator 405 may be fabricated from a plurality of stator laminations (not shown) stacked together along a thickness direction 422 of the stator 405. (It will be evident to those skilled in the art that the thickness direction of the rotor 404 and the stator 405 substantially coincide, and are therefore indicated via the same reference numeral 422.) Non-limiting examples of materials from which the stator 405 may be fabricated include silicon steel, and soft magnetic materials discussed in context of Example II below.

Even though in the embodiment 400, the stator 405 is shown as including a plurality of segmented structures (one of which is indicated explicitly via “thick” boundaries via reference numeral 406 in FIG. 4), those skilled in the art would appreciate that the stator 405 can also include a continuous structure (not shown for clarity), wherein any individual lamination, of the plurality of laminations of the stator 405, is fabricated as a single structure, as opposed to the individual laminations being “segmented” to form the segmented stator structure. Quite generally, the segmented stator structure helps improve a stator slot fill factor, hence improving the electric machine power density. The design of the segmented stator structure can be optimized according to the specific target application of the electrical machine. Non-limiting factors that need to be considered while optimizing the design of the segmented stator structure include a slot fill factor of the stator, and an amount of copper that is used in an end region (not indicated) of the stator. It is possible that the proposed optimizations would be geared towards increasing the stator slot fill factor, and towards reducing an amount of copper used in an end region, of the stator. Such optimizations are expected to result in a further reduction in size, and in manufacturing cost embodiments of the electric machine 400.

Furthermore, even though the plurality of electrical windings shown in FIG. 4 include a plurality of fractional slot concentrated electrical windings 408, that is, they extend across a single stator tooth between any two adjacent stator slots of the plurality of stator slots 407, those skilled in the art would appreciate that the electrical windings can be “distributed” (not shown for clarity), that is, any individual electrical winding, can extend across multiple adjacent stator teeth of the plurality of stator teeth 409 between stator slots belonging to the plurality of stator slots 407. A non-limiting example, of an individual distributed electrical winding, would be an electrical winding that extends across the stator slots 424 and 426. The stator 405 is separated from the rotor 404 by an air gap 401. Quite generally, use of the fractional slot concentrated winding configuration may result in a reduction and simplification of the electrical winding coil end turns (not shown), which consequently would result in a further reduction of the size, and manufacturing and assembling cost of the electrical machine 400.

FIG. 3 lists non-limiting examples of the slot-and-pole combinations that can support the fractional slot concentrated electrical windings of type 408 shown in FIG. 4. Slot-and-pole combinations are possible that can support both single-layer (1 coil side per slot) or a double-layer (2 coil side per slot) winding configurations. In one embodiment, the electrical machine 400 shown in FIG. 4 can include a plurality of fractional slot concentration windings 408 that include a single layer electrical winding configuration. Such a single layer electrical winding configuration, due to its simplified structure allows for a further reduction in manufacturing cost of embodiments of the electrical machine 400.

In one embodiment of the electric machine 400, the structure of the rotor 404 may be designed to have multiple layers of permanent magnets. It is possible that such a design results in an enhancement of reluctance torque component, a decreased permanent magnet torque component, and a decreased permanent magnet content. Enhanced levels of reluctance torque lead to correspondingly reduced levels of magnet torque of the rotor 404. The reduction in magnet torque in turn leads to a reduction in the amount of permanent magnet content required within the rotor 404. A reduction in the amount of required permanent magnet content, in turn results in a reduction in cost of the electrical machine 400. Furthermore, each of the permanent magnets that are disposed within the plurality of rotor poles 402 can be segmented in order to reduce eddy current losses. These factors are expected to result in a reduction in operational and/or manufacturing cost of the electric machine 400.

As is known in the art, for high-speed applications, enhanced operational electrical excitation frequencies are needed. It is also known in the art that eddy current losses in the stator 405 and rotor 404 increase with an increase in operational electrical excitation frequency. The eddy current losses in electrical machines can therefore be significant in high-speed applications.

As discussed herein, embodiments of the electrical machine 400 contain a plurality of fractional slot concentrated windings 408. Such fractional slot concentrated windings result in enhanced eddy current losses within the rotor 404 due to space sub-harmonic contents that are present. As discussed herein, the stator 405 may be fabricated so that it includes a plurality of “rotor” laminations. According to embodiments of the present invention, each of the plurality of “rotor” laminations may be fabricated from high resistivity soft magnetic materials. Similarly, as discussed herein, the stator 405 may be fabricated from a plurality of “stator” laminations. According to embodiments of the present invention, each of the plurality of “stator” laminations may be fabricated from high resistivity soft magnetic materials. Such fabrication of the plurality of stator 405 laminations, and the plurality of rotor 404 laminations, from high resistivity soft magnetic materials may help in a further reduction in the eddy current losses and thereby increase an efficiency of the electrical machine 400. In one embodiment of the invention, the high resistivity soft magnetic materials may be nanostructured.

In one embodiment of the invention, high resistivity hard magnetic materials may be realized from hard magnetic materials that have undergone suitable processing (discussed in detail in Example I below) and include compounds including at least one rare earth atom. Non-limiting examples of high resistivity hard magnetic material include ferrites such as barium-hexaferrites and strontium-hexaferrites, and alnico. In one embodiment of the invention, high resistivity soft magnetic materials may be realized from soft magnetic materials that have undergone suitable processing (discussed in detail in Example II below). Non-limiting examples of high resistivity soft magnetic material include amorphous metallic alloys, magnesium zinc ferrites, and nickel zinc ferrites.

In one embodiment of the invention, the permanent magnet content is fabricated from high resistivity hard magnetic materials. It is possible that the use of high resistivity nanostructured permanent magnets will mitigate a need for segmenting the permanent magnet content within the plurality of rotor poles 402 in order to reduce eddy current losses. This in turn will reduce a required permanent magnet piece count, which in turn may decrease assembling and manufacturing costs of the electrical machine 400.

Those skilled in the art would appreciate that alternate embodiments of the invention include an electrical machine including a first discontinuous volume comprising a high resistivity soft magnetic material. Non-limiting examples of the first discontinuous volume include the stator 405, and the rotor 404. A further non-limiting example of the first discontinuous volume is the “s”-bulk volume 430 that is complementary to the volume defined by and within the plurality of stator slots 407, that is, the “s”-bulk volume includes the “bulk” portions of the stator 405. In one embodiment of the electrical machine 400, the “s”-bulk volume includes a plurality of stator laminations that include high resistivity soft magnetic materials. A further non-limiting example of the first discontinuous volume is the “r”-bulk volume 432 that is complementary to the volume defined by and within the plurality of rotor poles 402, that is, the “r”-bulk volume includes the “bulk” portions of the rotor 404. In one embodiment of the electrical machine 400, the “r”-bulk volume includes the plurality of rotor laminations that include high resistivity soft magnetic materials.

Those skilled in the art would appreciate that alternate embodiments of the invention include an electrical machine, wherein the electrical machine (for example, of type 400) includes a stator (for example, of type 405) comprising a high resistivity soft magnetic composite (for instance, a soft magnetic material as discussed in Example II below), and a rotor comprising a high resistivity soft magnetic composite (for instance, a soft magnetic material as discussed in Example II below) and a high resistivity hard magnetic material (for instance, a hard magnetic material as discussed in Example I below). In one embodiment of the invention, the electrical machine includes a stator including a plurality of slots (for example, of type 407) and wherein a plurality of electrical windings (for instance, of type 408) are individually disposed between any two slots belonging to the plurality of stator slots. Non-limiting examples of the types of electrical winding includes slot concentrated electrical windings, wherein each individual electrical winding is extends across a single stator tooth), and distributed electrical windings (wherein each individual electrical winding extends across multiple stator teeth).

As discussed herein, embodiments of the invention include a stator that includes a plurality of stator teeth (for instance, of type 409). Quite generally, each tooth of the plurality of stator teeth includes a tooth tip volume, so that embodiment of the invention as discussed herein includes a plurality of tooth tip volumes 410. In one embodiment of the invention, a soft magnetic material (for instance, a soft magnetic material as discussed in Example II below) may be disposed within the plurality of tooth tip volumes 410.

Those skilled in the art would appreciate that embodiments of the invention include an electrical machine including a discontinuous “p”-volume comprising a high resistivity hard magnetic material. The volume defined by and within the plurality of poles 402 constitutes a non-limiting example of the discontinuous “p”-volume. The plurality of hard magnets 403 that are placed within the plurality of poles 402 of the rotor 404 is a non-limiting example defining the discontinuous “p”-volume. It may be evident that the plurality of rotor poles 402 are “embedded” within the rotor 404. Consequently, the plurality of permanent magnets 403, since they are disposed within the plurality of rotor poles 402, may be considered to be “embedded” within the rotor 404. Those skilled in the art would appreciate that, due to such an “interior” (“embedded”) placement of the plurality of rotor poles 402, or equivalently, of the plurality of permanent magnets 403, within the rotor 404, the embodiment 400 is an represents an “interior” permanent magnet electric machine.

Alternate embodiments of the invention include surface permanent magnet electrical machines, such as the surface permanent magnet electrical machine 500 shown schematically in FIG. 5. According to the embodiment 500, a plurality of poles 502 are disposed on the surface of the rotor 504. A generally cylindrical shaft 528 is defined as a generally centrally disposed opening within the rotor 504. According to the embodiment 500, the plurality of poles 502 include a plurality of hard magnets 503 such as the permanent magnets 546, 548, 550, and 552. Those skilled in the art would appreciate that the rotor 504 may be fabricated from a plurality of rotor laminations (not shown) stacked together along a thickness direction 522 (which lies along a z-axis of a right-handed Cartesian coordinate system 544) of the rotor 504. Non-limiting examples of materials from which the rotor 504 may be fabricated include silicon steel.

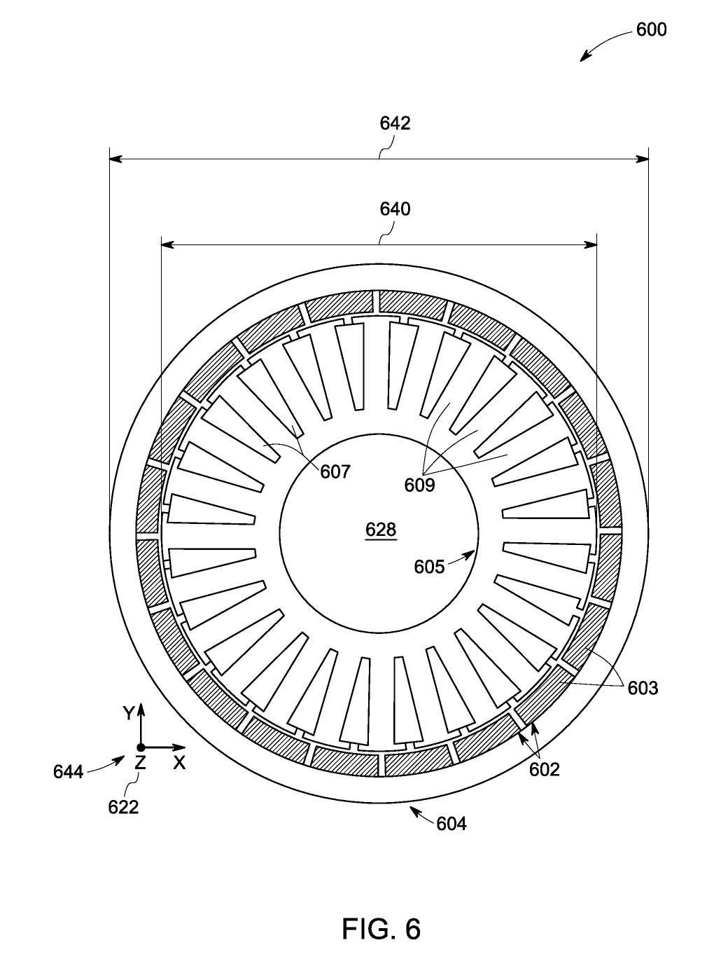

Alternate embodiments of the invention include electrical machines that are fabricated in “inside-out” configurations such as the permanent magnet electric machine 600 shown schematically in FIG. 6. According to the embodiment 600, a plurality of rotor poles 602 are disposed on the rotor 604. According to the embodiment 600, the plurality of rotor poles 602 include a plurality of permanent “hard” magnets 603. Those skilled in the art would appreciate that the rotor 604 may be fabricated from a plurality of rotor laminations (not shown) stacked together along a thickness direction 622 (which lies along a z-axis of a right-handed Cartesian coordinate system 644) of the rotor 604. As is evident from the “inside-out” embodiment 600 shown in FIG. 6, an outer diameter 640 of the stator 605 is less than an outer diameter 642 of the rotor 604. This is to be distinguished and compared against the “regular” electrical machine embodiment 400 shown in FIG. 4, wherein an outer diameter 440 of the stator 405 is greater than an outer diameter 442 of the rotor 404.

The embodiment 600 further includes a stator 605 which, as per the discussions herein, may include a segmented structure or a continuous structure, a plurality of stator slots 607, and a plurality of electrical windings (not shown), which, as per the discussions herein, may include concentrated electrical windings (which extend across a single stator tooth between any two adjacent stator slots of the plurality of stator slots 607), or distributed electrical windings (which extend across multiple adjacent stator teeth of the plurality of stator teeth 609 between stator slots belonging to the plurality of stator slots 607), wherein each electrical winding of the plurality of electrical windings is individually wound around an individual stator tooth or around multiple stator teeth belonging to a plurality of stator teeth 609. A generally cylindrical shaft 628 is defined as a generally centrally disposed opening within the stator 605. Those skilled in the art would appreciate that the stator 605 may be fabricated from a plurality of stator laminations (not shown) stacked together along a thickness direction 622 of the stator 605. Non-limiting examples of materials from which the rotor 604 may be fabricated include silicon steel, and hard magnetic materials and soft magnetic materials discussed respectively in context of Example I and Example II below.

The invention will be illustrated in further detail with reference to several examples below, which examples are not intended to limit the scope of the invention.

### Example I

### Method of Making a High Resistivity Hard Magnetic Material

In accordance with an embodiment of the invention, a high resistivity permanent magnetic material (that can be used, for instance, to fabricate the plurality of permanent magnets 403) is disclosed. Non-limiting examples of high resistivity permanent magnetic materials include high resistivity permanent magnetic materials including a non-conductive phase and a permanent magnetic phase microstructure. In one embodiment of the invention, the high resistivity permanent magnetic material has a resistivity of at least about 150 microohm centimeters, and an energy product of at least about 35 megaGauss Oersted (MGOe).

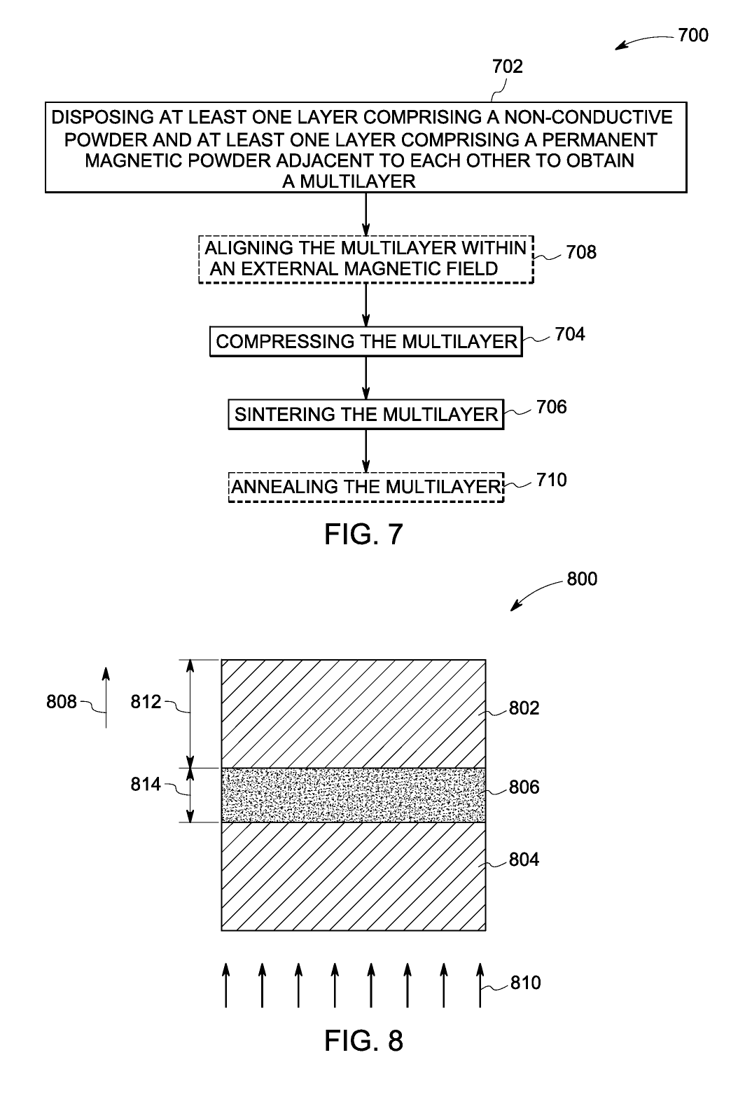

In accordance with an embodiment of the invention, a method 700, depicted via a flow chart in FIG. 7, to make a permanent magnetic material is disclosed. Step 702 of the method 700 includes disposing at least one layer of a non-conductive powder and at least one layer of permanent magnetic powder adjacent to each other to obtain a multilayer. Non-limiting examples of the permanent magnetic powder include a rare earth transition metal compound such as NdFeB or SmCo. Non-limiting examples of non-conductive powders include mixtures including a rare earth oxide, and non-metal oxides such as boron oxide. Further non-limiting examples of non-conductive powder include a mixture including a rare earth oxide and an oxide compound with softening point below a sintering temperature of the permanent magnetic powder material. In one embodiment of the invention, the oxide compound includes borate, alumino borate, borosilicate, or alumino silicate glasses of rare earth atoms. Step 704 of the method 700 includes compressing the multilayer. Non-limiting examples of techniques that may be used for compressing the multilayer include uniaxial compressing, isostatic compressing, hot isostatic compressing, die upset compressing, or spark plasma sintering. Step 706 of the method 700 includes sintering the multilayer. In one embodiment of the invention, the annealing is performed within a temperature range from about 400° C. to about 1000° C., and for a time duration of up to about 24 hours.

In one embodiment, the method 700 includes a further step 708 that includes aligning the multilayer within an external magnetic field. It is possible that the alignment within a magnetic field helps achieve optimal properties such as remanance and energy product of, for instance, the magnetic materials from which is composed the multilayer. In one embodiment, the method 700 includes a further step 710 of annealing the multilayer. The method 700 depicted in FIG. 7 is now discussed in more detail via FIG. 8.

FIG. 8 schematically depicts a non-limiting embodiment of a multilayer 800 as is recited as part of the method 700. The multilayer 800 includes layers 802 (having a thickness 812) and 804. Each of the layers 802 and 804 independently include at least one permanent magnetic material powder. In one embodiment of the invention, a thickness of the layer of permanent magnetic powder is within a range from about 1 micrometers to about 1 centimeters. The multilayer 800 further includes a layer 806 having thickness 814 disposed so that it is “sandwiched” between the layers 802 and 806. The layer 806 includes at least one non-conductive powder. In one embodiment of the invention, a thickness of the layer of non-conductive powder is less than about 1000 micrometers.

Processing of the multilayer 800 to obtain the high resistivity permanent magnet material may be performed according to the steps recited in method 700. For instance, the multilayer 800 according to step 702 may be prepared by filling a die with multiple layers to obtain the multilayer 800, such that alternating layers of the multilayer 800 respectively include, for instance, a powder including a permanent magnet material, and a powder including a non-conductive material. Further, the compression of the multilayer 800, as per the recitation of step 704 may be performed within the die that houses the multilayer 800.

The inventors have ascertained certain properties, which if displayed by permanent magnetic material, render it suitable for the purposes of fabricating a high resistivity permanent magnetic material according to embodiments of the present invention. A non-limiting example of such a property is the chemical reactivity of the hard magnetic material with the non-conductive material. This property is relevant during, for instance, the sintering step of the multilayer 800 as per the recitation of step 706. Considering as a non-limiting example, the example shown in FIG. 8, whereby a layer of a powder of a permanent magnet material 802 is disposed adjoining, that is, in close proximity, to a layer of a powder of non-conductive material 806. It has been ascertained that it may be advantageous for the powder of the permanent magnet material to possess a property whereby, at the temperatures encountered during the sintering, and the time period over which the sintering is to be performed, it does not undergo a chemical reaction with the layer of non-conductive material. In one embodiment of the invention, the sintering is performed within a temperature range from about 900° C. to about 1200° C. In one embodiment of the invention, the sintering is performed for a time duration of up to about 24 hours. Further, as recited by step 708, the multilayer 800 may be aligned along a non-limiting direction 808 within an external magnetic field 810.

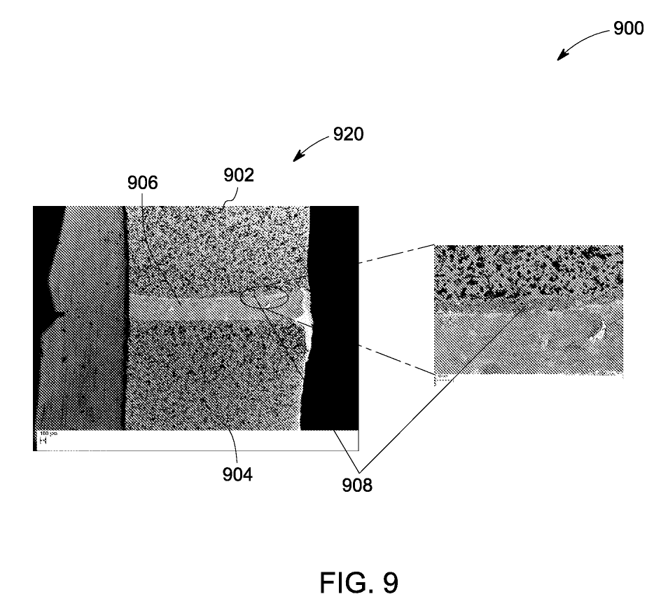

Non-limiting examples of materials from which can be obtained powders of permanent magnetic materials include rare earth based permanent magnets such as neodymium iron boron (NdFeB). Further, non-limiting examples of materials from which can be obtained powders of non-conductive materials include oxides. At the elevated temperatures at which sintering is performed according to the recitation of step 706, the ions of, for instance, the rare earth Nd, as are present in the permanent magnetic material, being highly reactive, will chemically react with and reduce the oxides from which are fabricated the non-conductive materials. The products of the reduction reaction will precipitate as an interaction layer. For instance, FIG. 9 shows a scanning electron microscope image 900 (the length scale of the image is indicated and is about 100 microns) of a multilayer 920 (for instance, of type 800) after it has undergone a sintering step (for instance, of type 706) as part of a manufacturing method (for example, of type 700). Substantially, as per the discussions in regard to the multilayer 800 shown in FIG. 8, the image 900 shows a multilayer 920 including layers 902 and 904 of permanent magnetic materials (which, in the present case is NdFeB), and layer 906 of a non-conductive material (which, in the present case is tantalum oxide). As may be evident from the image 900, the multilayer 920 further includes in interaction layer 908 that is disposed between, for instance, the layer of permanent magnetic material 902 and layer 906 of a non-conductive material. The interaction layer is likely precipitated as a chemical reaction product between the Nd of the NdFeB and the tantalum oxide. It is possible that, the presence of the interaction layer 908 will affect the operational performance of the permanent magnetic material.

In one embodiment of the invention, the non-conductive powder includes a rare earth oxide compound such as neodymium oxide or boron oxide. Considering the specific, non-limiting example of neodymium oxide, it has been ascertained that, neodymium oxide will likely not react, at the elevated temperatures at which sintering is performed, with elemental neodymium present within the permanent magnetic material. However, it was also ascertained that neodymium oxide likely does not sinter densely under the conditions needed to process permanent magnetic material such as NdFeB. It is likely that, by mixing the neodymium oxide as a minority fraction within an oxide with a low melting point, such as boron oxide, may help mitigate this issue. It is likely that, the above “mixing” step allows the neodymium oxide to sinter more densely. It is remarked that boron oxide also does react with the neodymium oxide. However this reaction, while unavoidable, was ascertained to not result in any substantial limitation to the operational performance of the permanent magnet content due the use of a minority fraction of boron oxide.

### Example II

### Method of Making a High Resistivity Soft Magnetic Material

In accordance with an embodiment of the invention, a high resistivity soft magnetic material is disclosed. Non-limiting examples of high resistivity soft magnetic materials include high resistivity soft magnetic materials from which may be fabricated stators (for instance, of type 405), or rotors (for instance, of type 404). The high resistivity soft magnetic materials include a microstructure including a bulk metallic glass phase and a soft magnetic crystalline metal phase. In one embodiment of the invention, the high resistivity soft magnetic material has a resistivity of at least about 50 microohm centimeters. In one embodiment of the invention, the high resistivity soft magnetic material has a resistivity of at least about 150 microohm centimeters. In one embodiment of the invention, the high resistivity soft magnetic material has a saturation magnetization of at least about 1.4 Tesla. In one embodiment of the invention, the bulk metallic glass phase includes Fe, Co, Zr, Mn, Zr, Hf, B, and C. In one embodiment of the invention, the soft magnetic crystalline metal phase includes Fe, Co, Ni, Mo, Cr, and C.

Quite generally, the soft magnetic material may include a composite that includes a first phase and a second phase. The first phase as well as the second phase will have characteristic length scales associated with them. As used herein, the term “characteristic length scale” refers to the length scale of the smallest physical dimension from amongst the physical dimensions of the phase under discussion. It is conceivable that, one of the phases, say, the first phase (for example, the soft magnetic crystalline metal), is embedded within a background of the second phase (for example, the bulk metallic glass), and together they constitute the composite. In one embodiment of the invention, a volume fraction of the bulk metallic glass material is greater than about 50%.

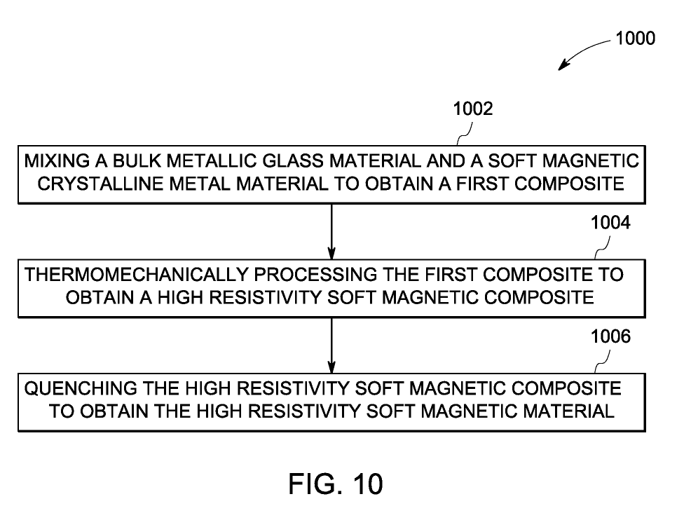

In accordance with an embodiment of the invention, a method 1000, depicted via a flow chart in FIG. 10, to make a high resistivity soft magnetic material is disclosed. Step 1002 of the method 1000 includes mixing a bulk metallic glass material and a soft magnetic crystalline metal material to obtain a first composite. Step 1004 of the method 1000 includes thermomechanically processing the first composite to obtain a high resistivity soft magnetic composite. In one embodiment of the invention, the thermomechanical processing is performed within a temperature range from about T_{G} to about T_{M}, wherein T_{G} represents the glass transition temperature of the bulk metallic glass material and T_{M} represents the crystallization temperature of the bulk metallic glass material remains in a glassy state after the thermomechanical processing. Step 1006 of the method 1000 includes quenching the high resistivity soft magnetic composite to obtain the high resistivity soft magnetic material.

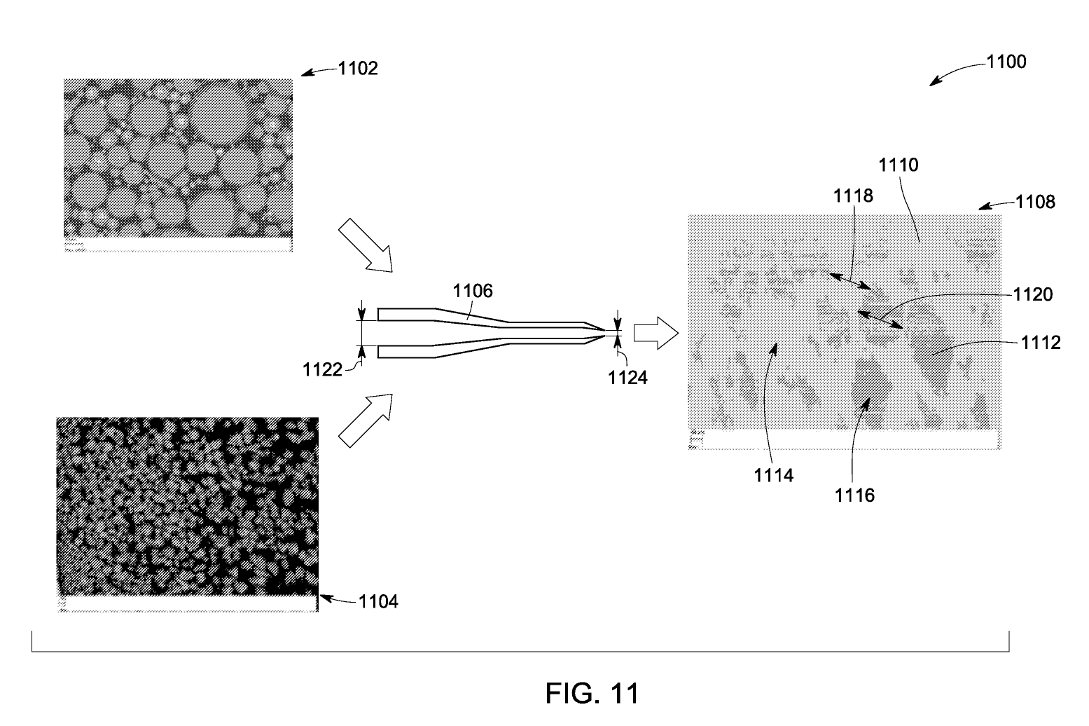

FIG. 11 schematically depicts a non-limiting embodiment of processes 1100 which may be employed to perform method 1000 (FIG. 10). For example, FIG. 11, shows scanning electron microscope images 1102 and 1104 of a bulk metallic glass material and a soft magnetic crystalline material respectively. The distinguishing property of the bulk metallic glass material is its high resistivity, while the distinguishing property of the soft magnetic crystalline material is its high saturation magnetization. The bulk metallic glass material and the soft magnetic crystalline material are mixed together to obtain a first composite according to the recitation of step 1002. Next, as per the recitation of step 1004, the first composite is thermomechanically processed, for instance, via a warm extrusion can 1106 to obtain a high resistivity soft magnetic composite. In one embodiment of the invention, an extrusion ratio, defined as the ratio of an input diameter 1122 to an output diameter 1124 of the extrusion can 1106, of the warm extrusion step lies between about 3:1 to about 5:1. Other non-limiting techniques for thermomechanically processing the first composite include rolling, hot pressing, and spark plasma sintering. Reference numeral 1108 indicates a scanning electron microscope image of the high resistivity soft magnetic material that is obtained from high resistivity soft magnetic composite subsequent to quenching as per the recitation of step 1006. The image 1108 reveals the high resistivity soft magnetic material as including a bulk metallic glass phase 1110 (“first phase”) and a soft magnetic crystalline metal phase 1112 (“second phase”). In one embodiment of the invention, a characteristic length scale 1118 associated with the first phase lies within a range from about 1 micron to about 39 microns. In one embodiment of the invention, a characteristic length scale 1120 associated with the second phase lies within a range from about 100 microns to about 500 microns.

In one embodiment of the invention, a raw material for forming the bulk metallic glass material is formed via a gas atomization process, and contains particles that are about 400 mesh or finer in size. In one embodiment of the invention, a raw material for forming the soft magnetic crystalline metal material is formed via a water atomization process, and contains particles that are about 125 mesh or coarser in size. Quite generally, it may be evident that the high resistivity soft magnetic composite is fabricated out of a powder including particles having a bimodal size distribution including a first peak and a second peak. In one embodiment of the invention, the first peak is centered at about 20 microns and has a width of about 10 microns. In one embodiment of the invention, the second peak is centered at about 100 microns and has a width of about 50 microns.

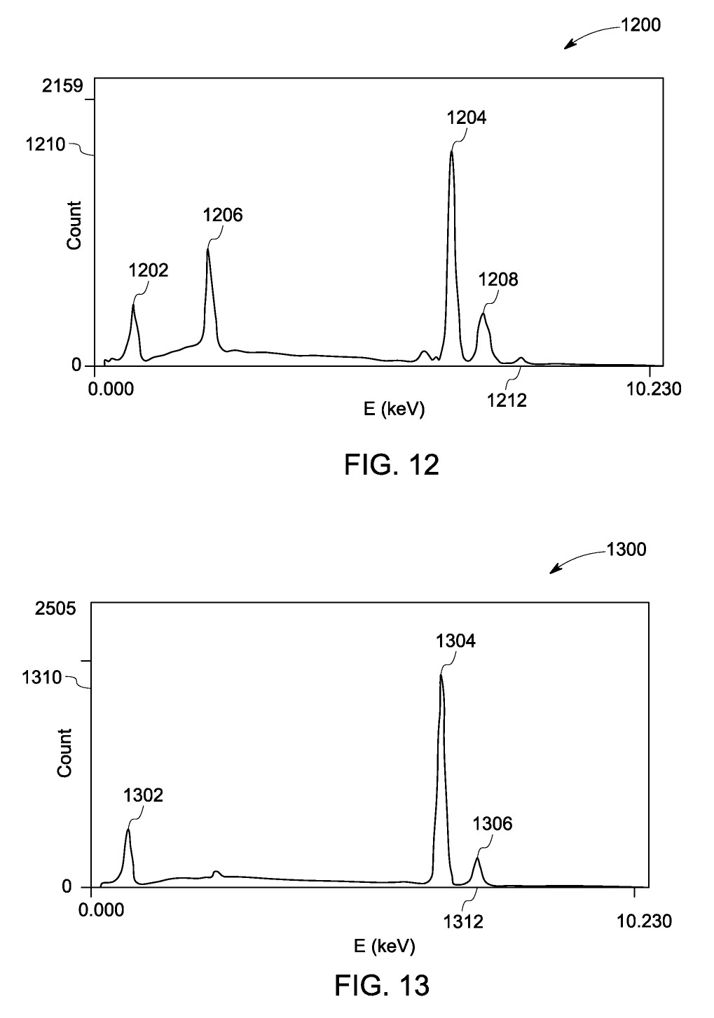

Further energy dispersive analysis of X-ray (EDAX) studies were performed to confirm the two-phase nature of the high resistivity soft magnetic material depicted in image 1108. For instance, EDAX spectra were obtained substantially at the locations 1114 and 1116 within the image 1108, and are presented in FIG. 12 and FIG. 13 respectively. EDAX spectrum 1200 presented in FIG. 12 shows the results of an EDAX study wherein a “count” number is shown (plotted along an ordinate 1210) as a function of energy “E” expressed in kilo electronvolt (keV) (plotted along an abscissa 1212). The EDAX spectrum 1200 reveals Fe peaks 1202 and 1204, a Zr peak 1206, and a Co peak 1208 at the expected locations confirming that the chemical composition of the location 1114 is indeed that of a bulk metallic glass. Similarly, the EDAX spectrum 1300 presented in FIG. 13 shows the results of an EDAX study wherein a “count” number is shown (plotted along an ordinate 1310) as a function of energy “E” expressed in keV (plotted along an abscissa 1312). The EDAX spectrum 1300 reveals Fe peaks 1202, 1204, and 1206 at the expected locations confirming that the chemical composition of the location 1116 is indeed that of a soft magnetic crystalline metal phase.

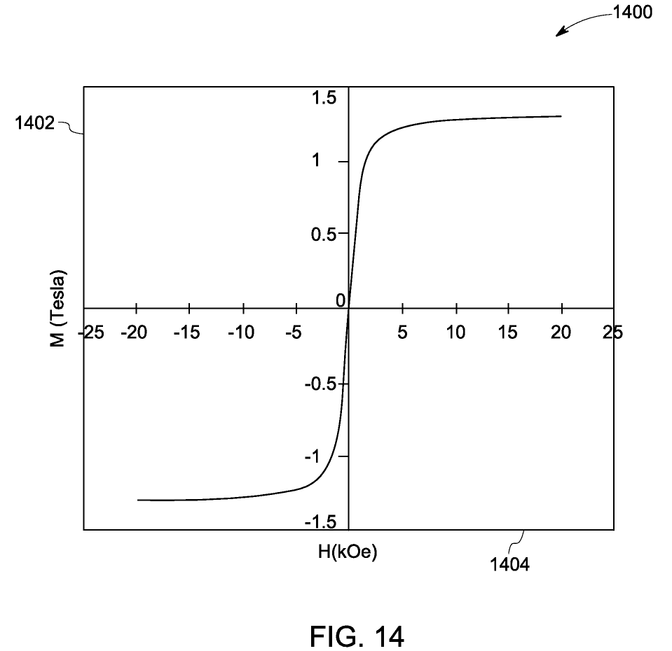

Field dependent magnetization studies were performed to confirm the soft magnetic nature of the high resistivity soft magnetic material. FIG. 14 shows a graph 1400 of the results of measurement of magnetization “M” expressed in Tesla (plotted along an ordinate 1402) as a function of applied magnetic field “H” expressed in kilo oersted (kOe) (plotted along an abscissa 1404) for the high resistivity soft magnetic material obtained via method 1100. One sees that the magnetization “M” achieves technical saturation for a applied magnetic field “H” of about 3 kOe, attesting to the soft nature of the magnetic state of the high resistivity soft magnetic material.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method to make a high resistivity permanent magnetic material comprising a non-conductive phase and a permanent magnetic phase microstructure, said method comprising the steps of:
(a) disposing at least one layer comprising a non-conductive powder and at least one layer comprising a permanent magnetic powder adjacent to each other to obtain a multilayer;
(b) compressing the multilayer; and
(c) sintering the multilayer.

2. The method of claim 1, further comprising a step of aligning the multilayer within an external magnetic field.

3. The method of claim 1, further comprising a step of annealing the multilayer.

4. The method of claim 1, wherein the non-conductive powder comprises a rare earth oxide compound.

5. The method of claim 1, wherein the non-conductive powder comprises a mixture comprising a rare earth oxide, and non-metal oxides such as boron oxide.

6. The method of claim 1, wherein the non-conductive powder comprises a mixture comprising a rare earth oxide and an oxide compound with softening point below a sintering temperature of the permanent magnetic powder material.

7. The method of claim 6, wherein the oxide compound comprises borate, alumino borate, borosilicate, or alumino silicate glasses of rare earth atoms.

8. The method of claim 1, wherein the permanent magnet powder comprises a rare earth transition metal compound.

9. The method of claim 1, wherein the permanent magnet powder comprises a compound comprising NdFeB, or SmCo.

10. The method of claim 1, wherein a thickness of the layer of permanent magnetic powder is within a range from about 1 micrometer to about 1 centimeter.

11. The method of claim 1, wherein a thickness of the layer of non-conductive powder is less than about 1000 micrometer.

12. The method of claim 1, wherein the technique used for compressing comprises uniaxial compressing, isostatic compressing, hot isostatic compressing, die upset compressing, or spark plasma sintering.

13. The method of claim 1, wherein the sintering is performed within a temperature range from about 900° C. to about 1200° C.

14. The method of claim 1, wherein the sintering is performed for a time duration of up to about 24 hours.

15. The method of claim 1, wherein the annealing is performed within a temperature range from about 400° C. to about 1000° C.

16. The method of claim 1, wherein the annealing is performed for a time duration of up to about 24 hours.

17. The method of claim 1, wherein the high resistivity permanent magnetic material has a resistivity of at least about 150 microohm centimeter.

18. The method of claim 1, wherein the high resistivity permanent magnetic material has an energy product of at least about 35 MGOe.

19. The method of claim 1, wherein the layer comprising a non-conductive powder further comprises a permanent magnetic powder.

20. A method to make a high resistivity soft magnetic material comprising a microstructure comprising a bulk metallic glass phase and a soft magnetic crystalline metal phase, said method comprising the steps of:
(a) mixing a bulk metallic glass material and a soft magnetic crystalline metal material to obtain a first composite;
(b) thermomechanically processing the first composite to obtain a high resistivity soft magnetic composite; and
(c) quenching the high resistivity soft magnetic composite to obtain the high resistivity soft magnetic material.

21. The method of claim 20, wherein a volume fraction of the bulk metallic glass material is greater than about 50%.

22. The method of claim 20, wherein the bulk metallic glass material comprises Fe, Co, Mn, Zr, Hf. B, or C.

23. The method of claim 20, wherein the thermomechanical processing is performed within a temperature range from about T_{G} to about T_{M}, wherein T_{G} represents the glass transition temperature of the bulk metallic glass material and T_{M} represents the crystallization temperature of the bulk metallic glass material.

24. The method of claim 20, wherein the bulk metallic glass material remains in a glassy state after the thermomechanical processing.

25. The method of claim 20, wherein a raw material for forming the bulk metallic glass material is formed via a gas atomization process.

26. The method of claim 25, wherein a raw material for forming the bulk metallic glass material is 400 mesh or finer in size.

27. The method of claim 20, wherein the soft magnetic crystalline metal material comprises Fe, Co, Ni, Mo, Cr, or C.

28. The method of claim 20, wherein a raw material for forming the soft magnetic crystalline metal material is formed via a water atomization process.

29. The method of claim 28, wherein a raw material for forming the soft magnetic crystalline metal material is 125 mesh or coarser in size.

30. The method of claim 20, wherein techniques for thermomechanically processing the first composite include warm extrusion, rolling, hot pressing, or spark plasma sintering.

31. The method of claim 30, wherein an extrusion ratio of the warm extrusion step lies between about 3:1 to about 5:1.

32. The method of claim 20, wherein the high resistivity soft magnetic material has a resistivity of at least about 50 microohm centimeter.

33. The method of claim 20, wherein the high resistivity soft magnetic material has a resistivity of at least about 150 microohm centimeter.

34. The method of claim 20, wherein the high resistivity soft magnetic material has a saturation magnetization of at least about 1.4 Tesla.
